(19) United States
(12) Patent Application Publication
(10) Pub. No.: US 2025/0315092 A1
(43) Pub. Date: Oct. 9, 2025

(54) INTERCONNECT DEVICE POWER ALLOCATION

(71) Applicant: MELLANOX TECHNOLOGIES, LTD., Yokneam (IL)

(72) Inventors: Amit Kazimirsky, Givat-Shmuel (IL); Nir Sucher, Ramat Hashofet (IL)

(21) Appl. No.: 18/627,972

(22) Filed: Apr. 5, 2024

(51) Int. Cl. G06F 1/3206

(52) U.S. Cl. CPC G06F 1/3206

(57) ABSTRACT

An interconnect device is provided. In one example, an interconnect device includes ports and circuits to receive measurements from two or more switching devices; determine, based on the measurements, a relative power consumption of each switching device from the two or more switching devices; generate, based on the relative power consumption of each switching device from the two or more switching devices, respective power instructions for each switching device from the two or more switching devices; and distribute the respective power instructions to each switching device from the two or more switching devices.

### FIELD OF THE DISCLOSURE

The present disclosure is generally directed toward networking and, in particular, toward networking devices and methods of operating the same.

### BACKGROUND

Switches and similar network devices represent a core component of many communication, security, and computing networks. Switches are often used to connect multiple devices, device types, networks, and network types.

Devices including but not limited to personal computers, servers, or other types of computing devices, may be interconnected using network devices such as switches. Such interconnected entities form a network that enables data communication and resource sharing among the nodes.

### BRIEF SUMMARY

In accordance with one or more embodiments described herein, a computing system, such as an interconnect device, may enable a diverse range of systems, such as switches, servers, personal computers, and other computing devices, to communicate across a network. Such a computing system, which may be referred to herein as an interconnect device, a switch, or a controller, may be enabled to receive power consumption and/or bandwidth data from one or more devices, generate power instructions based at least in part on the received data, and distribute the instructions to the one or more devices. As a result of the instructions, each device may be enabled to operate in a manner such that performance across the devices is increased and/or made more efficient. Implementing power instructions may cause additional power to be budgeted to less efficient devices and less power to be budgeted to more efficient devices. As a result, bandwidth across the devices may substantially be equalized. In some implementations, other data, such as indications of the devices using throttling mechanisms, or indications of particular applications executing on the devices or other computing systems, may be used, at least in part, to generate the power instructions. Also, in some implementations an interconnect device or controller may cause other scenarios to occur in response to measurement data, such as allocating additional power to particular devices such that bandwidth, packet rates, compute operations, and/or other variables may be increased for those particular devices as compared to other devices. As should be appreciated based on the detailed description provided herein, the systems and methods described herein may enable a wide range of possible options for performance.

In an illustrative example, a device is disclosed that includes one or more circuits to: receive measurements from two or more switching devices; determine, based on the measurements, a relative power consumption of each switching device from the two or more switching devices; generate, based on the relative power consumption of each switching device from the two or more switching devices, respective power instructions for each switching device from the two or more switching devices; and distribute the respective power instructions to each switching device from the two or more switching devices.

In another example, a method is disclosed that includes receiving measurements from two or more switching devices; determining, based on the measurements, a relative power consumption of each switching device from the two or more switching devices; generating, based on the relative power consumption of each switching device from the two or more switching devices, respective power instructions for each switching device from the two or more switching devices; and distributing the respective power instructions to each switching device from the two or more switching devices.

In yet another example, a computing system disclosed that includes a plurality of switching circuits and a controller circuit to: receive measurements from the plurality of switching circuits; determine, based on the measurements, a relative power consumption of each switching circuit from the plurality of switching circuits; generate, based on the relative power consumption of each switching device, respective power instructions for each switching circuit from the plurality of switching circuits; and distribute the respective power instructions to each switching circuit from the plurality of switching circuits.

Any of the above example aspects include wherein each switching device from the two or more switching devices performs a workload for a computing device, wherein in response to distributing the respective power instructions to each switching device from the two or more switching devices, one or more of bandwidth of traffic, packet rates, and compute operations across the two or more switching devices are substantially equalized.

Any of the above example aspects include wherein the one or more circuits are further to store the respective power instructions for each switching device from the two or more switching devices in memory and associate the respective power instructions with one or more applications executed by the computing device.

Any of the above example aspects include wherein the one or more circuits are further to receive data associated with one or more throttling mechanisms performed by at least one of the two or more switching devices, wherein the respective power instructions are generated further based on the data associated with one or more throttling mechanisms.

Any of the above example aspects include wherein, in response to distributing the respective power instructions, a rate of throttling occurrences across the two or more switching devices is reduced.

Any of the above example aspects include wherein the one or more circuits are further to determine an average power consumption over a period of time for each switching device from the two or more switching devices.

Any of the above example aspects include wherein the relative power consumption comprises an average relative power consumption of each switching device from the two or more switching devices over time.

Any of the above example aspects include wherein in response to distributing the respective power instructions to each device from the two or more devices, more power is allocated to one or more devices of the two or more devices than other devices of the two or more devices.

Any of the above example aspects include wherein one or more of bandwidth of traffic, packet rates, and compute operations across the one or more devices increase relative to the other devices.

Any of the above example aspects include wherein the measurements comprise one or more of power measurements and performance measurements.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a network in accordance with at least some embodiments of the present disclosure;

FIG. 2 is a block diagram depicting an illustrative configuration of an interconnect device in accordance with at least some embodiments of the present disclosure;

FIG. 3 is a block diagram depicting an illustrative configuration of routing circuitry of an interconnect device in accordance with at least some embodiments of the present disclosure;

FIG. 4 is a block diagram depicting a controller in accordance with at least some embodiments of the present disclosure; and

FIG. 5 is a flowchart depicting an illustrative configuration of a method in accordance with at least some embodiments of the present disclosure.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

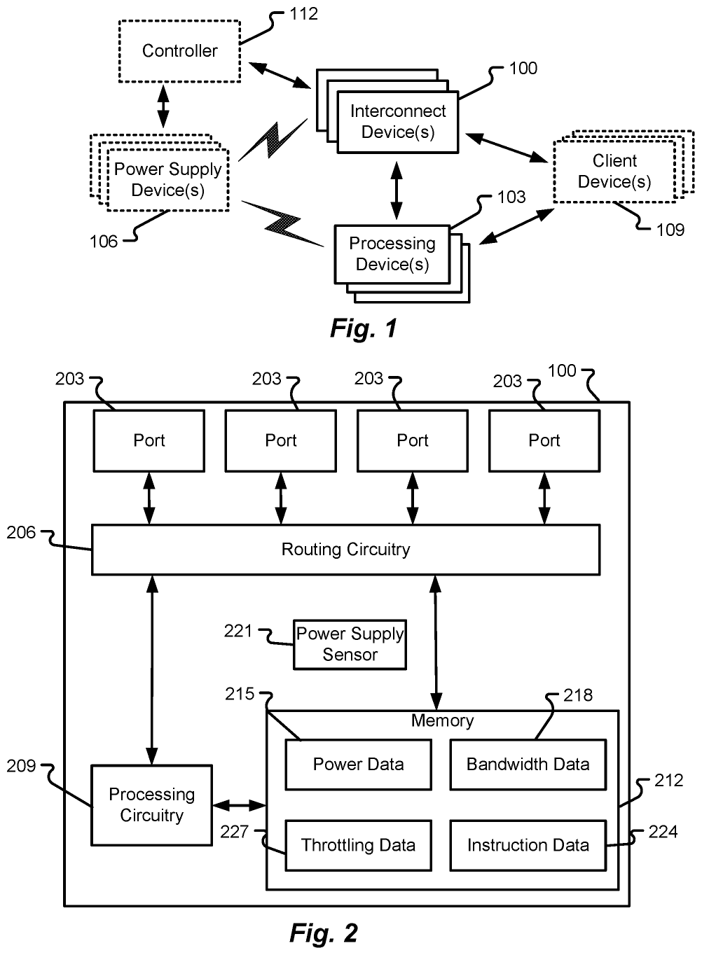

Referring now to FIGS. 1-5, various systems and methods for implementing power instructions in interconnect devices will be described. The concepts of power instructions depicted and described herein can be applied to any type of computing system capable of receiving and/or transmitting data, whether the computing system includes one port or a plurality of ports. Such a computing system may be a switch, but it should be appreciated any type of computing system may be used. The ability of interconnect devices, such as switches, to traverse data is constantly increasing, forwarding packet-processing is becoming more complex as a result power-requirements, and power-density of interconnect devices is increasing.

In a network in which a group of interconnect devices is used to transmit data, the performance of the network may be determined by the worst performing interconnect device of the network. For example, in situations in which a device sprays traffic across a number of different interconnect devices, faster or more efficient interconnect devices may sit idle while slower or less efficient interconnect devices may experience congestion.

The speed at which an interconnect device forwards data, and the maximum bandwidth an interconnect device is capable of transmitting, can be directly related to the amount of power consumed by the interconnect device. As power consumed by an interconnect device increases, the amount of data transmitted by the interconnect device likewise increases, provided no change in efficiency of the device. Similarly, a decrease in power may result in less data, or lower bandwidth, transmitted by the interconnect device.

Each interconnect device may have a different level of efficiency. More efficient interconnect devices may be capable of offering greater levels of bandwidth at lower levels of power consumption as compared to less efficient interconnect devices. To enable interconnect devices of varying levels of efficiency to operate at a substantially similar bandwidth, power instructions as described herein may be used to allocate particular amounts of power to each interconnect device in a network based on measurement data such as bandwidth. For example, more power can be budgeted to less efficient interconnect devices and less power can be budgeted to more efficient interconnect devices.

Conventionally, each interconnect device in a system receives the same amount of power and is sent the same amount of traffic. This results in more efficient interconnect devices receiving excessive power as they do not need as much power to send the data and less efficient interconnect devices receiving too little power and experiencing congestion and/or performing throttling mechanisms as the less efficient interconnect devices struggle to send the data with the limited power they receive. However, by providing power instructions as described herein, interconnect devices of varying levels of efficiency can be enabled to perform a similar amount of work, such that traffic can be spread across the interconnect devices evenly. In this way, the budget for each interconnect device can be optimized based on the power consumption of the particular interconnect device.

GPUs and other processing devices sending data through a network rely on each interconnect device in the network equally and are thus limited by the slowest interconnect device in the network. For this reason, by increasing power to less efficient switches and decreasing power to more efficient interconnect devices through the systems and methods described herein enables the achievement of data traversing through each of the interconnect devices at substantially the same rate.

As illustrated in FIG. 1, a computing environment as described herein may include a network of processing devices 103 interconnected by interconnect devices 100. One or more interconnect devices 100 may be in communication with one or more processing devices 103. The network of processing devices 103 and interconnect devices 100 may be in communication with one or more client devices 109. The processing devices 103 and interconnect devices 100 may be powered by one or more power supply devices 106. In some implementations, a controller 112 may be in communication with one or more interconnect devices 100 and/or the power supply devices 106. In some implementations, the functions of the controller 112 described herein may be performed by a processor of a power supply device 106. Such a network of processing devices 103 and interconnect devices 100 may be useful in various settings, from data centers and cloud computing infrastructures to artificial intelligence systems.

Processing devices 103 may be computing units, such as personal computers, servers, or other computing devices, and may be responsible for executing applications and performing data processing tasks. Processing devices 103 as described herein can range from servers in a data center to desktop computers in a network, or to devices such as internet of things (IoT) sensors and smart devices.

Each processing device 103 may include one or more processing circuits, such as graphics processing units (GPUs), central processing units (CPUs), application-specific integrated circuits (ASICs), field programmable gate arrays (FPGAs), or other circuitry capable of performing computations, as well as memory and storage resources to run software applications, handle data processing, and perform specific tasks as required. In some implementations, processing devices 103 may additionally or alternatively include hardware such as GPUs for handling intensive tasks for machine learning, artificial intelligence (AI) workloads, or other complex processes.

For example, processing devices 103 may operate as a high-performance computing (HPC) cluster. A cluster of processing devices 103 may comprise numerous interconnected servers, each equipped with powerful CPUs and/or GPUs. The processing devices 103 may provide computational horsepower for, as an example, training large-scale AI models or running complex scientific simulations. For AI and machine learning tasks, the processing devices 103 may comprise one or more GPUs or other processing circuitry which may be capable of handling parallel processing requirements of neural networks and other applications.

Interconnect devices 100, as described in greater detail herein, may enable communication between processing devices 103 and/or client devices 109. An interconnect device 100 may be, for example, a switch, a network interface controller (NIC), or other device capable of receiving and sending data, and may act as a central node in the network. Interconnect devices 100 may be wired in a topology including spine switches and top-of-rack (TOR) switches for example. Interconnect devices 100 may be capable of receiving, processing, and forwarding data, e.g., packets, to appropriate destinations within the network, such as processing devices 103 and/or client devices 109. In some implementations, an interconnect device 100 may be included in a switch box, a platform, or a case which may contain one or more interconnect devices 100 as well as one or more power supply devices 106 and/or controllers 112.

In some implementations, each processing device 103 may be connected to one or more ports of one or more interconnect devices 100 via network cables or wirelessly. Processes, such as applications, executed by processing devices 103 may involve transmitting data to nodes of the network, such as to other processing devices 103 and/or to client devices 109. Data may flow through the network of processing devices 103 and interconnect devices 100 using one or more protocols such as transmission control protocol (TCP), user datagram protocol (UDP), or Internet protocol (IP), for example. Each interconnect device 100 may, upon receiving data from a processing device 103 or another interconnect device 100, examine the data to identify a destination for the data and route the data through the network.

Each interconnect device 100 may receive power from a power supply device 106 shared by one or more interconnect devices 100 and/or processing devices 103, from a power supply device 106 contained within the interconnect device 100, or from a power supply device 106 dedicated to the interconnect device 100. A power supply device 106 may comprise a power regulator or other power supply circuitry. In some implementations, a power supply device 106 may supply power to a voltage regulator (VR) which may sustain power as required for a particular interconnect device 100. For example, a VR may sustain 600 watts, although applications executed by an interconnect device 100 may on average consume much less power.

Power supply devices 106 supplying power to interconnect devices 100 may supply such power at various power levels. An interconnect device 100, as described in greater detail below, may be enabled to consume a particular amount of power at any given time from the power supply devices 106. The amount of power consumed by an interconnect device 100 may be based on power instructions received from a controller 112 or from another interconnect device 100. Upon receiving the power instructions, an interconnect device 100 may be enabled to increase or decrease its power consumption to a rate reflected in the received power instructions. Such power instructions may cause more efficient interconnect devices 100 to consume less power and less efficient interconnect devices 100 to consume additional power.

When an interconnect device 100 is not actively being used by a processing device 103 to transmit data, the interconnect device 100 may enter a standby or low-power mode. During such times, the interconnect device 100, while not consuming more than an average amount of power, may be capable of receiving, processing, and forwarding a packet when needed. As such, the power supply device 106 may supply interconnect devices 100 sufficient power to meet demands of processing devices 103. The power supply device(s) 106 may be capable of supporting both the interconnect devices 100 and the processing devices 103 with sufficient power to accomplish necessary tasks at the proper times. The power instructions may be used by an interconnect device 100 to set a maximum power consumption. For example, upon receiving power instructions, the interconnect device 100 may control its operation in such a way as to not exceed the maximum power consumption.

Client devices 109 as described herein may be computing devices which, for example, engage in AI-related, research-related, and other processor-intensive tasks, and utilize processing devices 103 to handle the computational loads and data throughput required by such intensive applications. Client devices 109 may include, for example, workstations and personal computers used by researchers, data scientists, and professionals for developing, testing, and running AI models and research simulations. Client devices 109 may include one or more CPUs and/or GPUs but may require additional computational power for complex tasks.

By interacting with processing devices 103, client devices 109 may be enabled to perform functions such as training machine learning models, performing data processing, running simulations, analyzing large datasets, and performing complex data processing tasks, such as data mining, pattern recognition, and predictive modeling, for examples.

A controller 112 as described herein may be a computing unit, such as a personal computer, server, or other computing device, and may be responsible for receiving measurement data from interconnect devices 100, generating power instructions, and distributing the power instructions to the interconnect devices 100. A controller 112 as described herein can may include one or more processing circuits, such as GPUs, CPUs, ASICs, FPGAs, or other circuitry capable of performing computations, as well as memory and storage resources to run software applications, handle data processing, and perform specific tasks as required. In some implementations, a controller 112 may additionally or alternatively include hardware such as GPUs for handling intensive tasks for machine learning, AI workloads, or other complex processes.

An interconnect device 100 as described herein may in some implementations be as illustrated in FIG. 2. Such an interconnect device 100 may include a plurality of ports 203, routing circuitry 206, processing circuitry 209, and memory 212.

The ports 203 of an interconnect device 100 may be capable of facilitating the transmission of data packets, or non-packetized data, into, out of, and through the interconnect device 100. Such ports 203 may serve as interface points where network cables may be connected, connecting the interconnect device 100 with other interconnect devices 100, processing devices 103, and/or client devices 109.

Each port 203 may be capable of receiving incoming data packets from other devices and/or transmitting outgoing data packets to other devices. In some implementations, ports 203 may be configured to operate as either dedicated ingress or egress ports 203 or may be enabled to operate in a dual functionality capable of performing ingress and egress functions. For example, an egress port 203 may be used exclusively for sending data from the interconnect device and an ingress port 203 may be used solely for receiving incoming data into the switch.

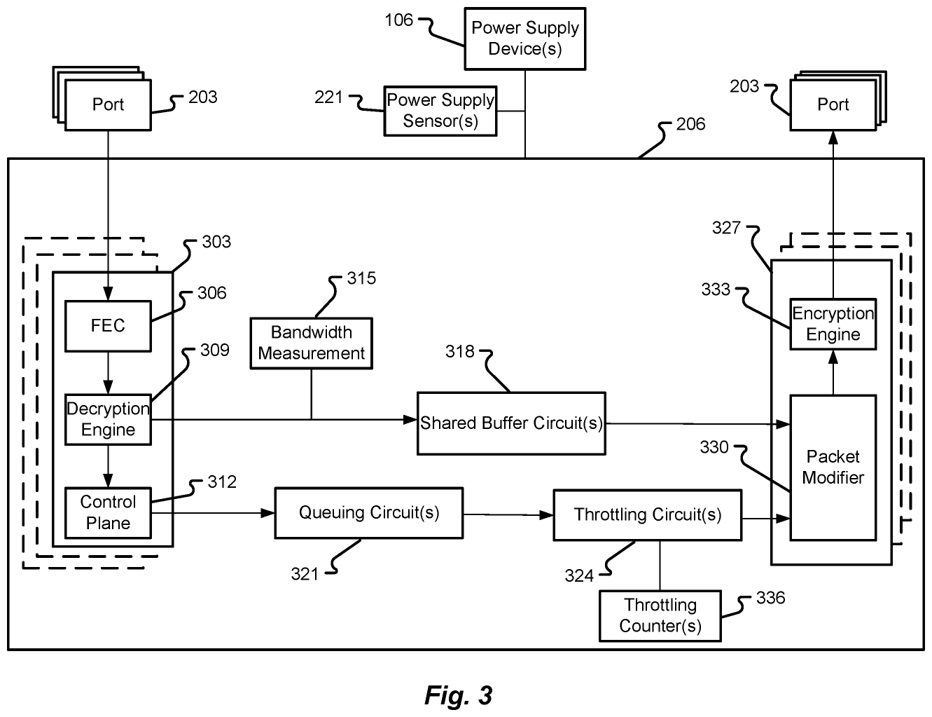

Routing circuitry 206 of an interconnect device 100, as described in greater detail below and in relation to FIG. 3, may be capable of handling a received packet by determining a port from which to send the packet and forwarding the packet from the determined port. The rate at which the routing circuitry 206 of a given interconnect device may be based at least in part on power instructions. For example, an interconnect device 100 may, through the use of power instructions, be instructed to consume less power than previously. As a result, the interconnect device 100 may begin consuming less power and as a result less data may traverse the interconnect device 100. In this way, the routing circuitry 206 may be capable of operating at various levels of power consumption and at various levels of bandwidth as described in greater detail herein.

In support of the functionality of the routing circuitry 206, processing circuitry 209 may be configured to control aspects of the routing circuitry 206 to accomplish power consumption management. The processing circuitry 209 may in some implementations include a CPU, an ASIC, and/or other processing circuitry which may be capable of handling computations, decision-making, and management functions required for operation of the interconnect device 100.

Processing circuitry 209 may be configured to handle power management and control functions of the interconnect device 100, such as setting up routing tables, configuring ports, and otherwise managing operation of the interconnect device 100. Processing circuitry 209 may execute software and/or firmware to configure and manage the interconnect device 100, such as an operating system and management tools. In some implementations, the processing circuitry 209 may be configured to receive power consumption and other data from external devices such as other interconnect devices 100. Processing circuitry 209 of an interconnect device 100 may be capable of analyzing data received from other interconnect devices 100, determining relative power consumption and/or bandwidth levels, generating power instructions for each of the other interconnect devices 100 and/or for the interconnect device 100 itself, and transmitting the power instructions to the other interconnect devices 100 as described in greater detail below. In such an implementation, an interconnect device 100 may perform the features of a controller 112 as described herein and a dedicated controller 112 may not be necessary. The routing circuitry 206 may be enabled to draw a particular amount of power from a power supply device 106 based on power instruction data 224 stored in memory 212 of the interconnect device 100.

The processing circuitry 209 may also be capable of storing such power instructions in memory 212 such as in the form of instruction data 224. Memory 212 of an interconnect device 100 as described herein may comprise one or more memory elements capable of storing configuration settings, instruction data 224, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

Memory 212 of an interconnect device 100 may also store data such as power data 215, bandwidth data 218, and throttling data 227. As the interconnect device 100 operates, the interconnect device 100 may collect such data in a number of ways, such as by sampling and/or making calculations.

Power data 215 may be acquired by monitoring power consumption using one or more power supply sensors 221. Such power supply sensors 221 may measure a total power consumption of the interconnect device 100 or power usage of particular components within the interconnect device 100.

Bandwidth data 218 may be acquired using sensors or counters which may monitor the flow of data through the interconnect device 100. The bandwidth may be measured at one or more of various points in the interconnect device 100, such as at ingress ports 203, egress ports 203, buffers, or other locations. Bandwidth data 218 may be calculated by summing a total bandwidth or a bandwidth rate measured by a plurality of sensors or counters. For example, each port 203 may be associated with a different bandwidth sensor and processing circuitry 209 may sum the total bandwidth of all ports 203.

To maintain performance and prevent overload, an interconnect device 100 may be enabled to employ one or more throttling mechanisms. A throttling mechanism, when activated, may temporarily limit and width available to certain ports and/or traffic types. Throttling data 227 may be acquired using one or more counters which may track each time a throttling mechanism is activated. Throttling data 227 may include information about each throttling event, including, for example, a time of activation, a duration, affect ports, affect traffic types, and/or other information.

Each of the power data 215, bandwidth data 218, and throttling data 227 may be timestamped and stored in memory 212. The power data 215, bandwidth data 218, and throttling data 227 may be sampled at predefined sampling rates or may be measured continuously. In some implementations, one or more of the power data 215, bandwidth data 218, and throttling data 227 may be used to compute information such as an average power consumption, average bandwidth, average number of throttling mechanisms performed, and/or other information. In some implementations, one or more of the power data 215, bandwidth data 218, and throttling data 227 may be compared with one or more of the power data 215, bandwidth data 218, and throttling data 227 to determine variables such as a power per bandwidth utilization over time.

The power data 215, bandwidth data 218, and throttling data 227 may be transmitted to another interconnect device 100, a controller 112, or other type of computing system. Such a system may be configured to receive power data 215, bandwidth data 218, and throttling data 227 from a number of interconnect devices 100 and to generate power instructions based on the power data 215, bandwidth data 218, and throttling data 227 from each device as described below in relation to the method 500 of FIG. 5. Each interconnect device 100 may receive in return a power instruction which may be used to determine a level of power consumption at which the interconnect device 100 should operate.

In some implementations, an interconnect device 100 as described herein may include one or more power supply sensors 221. A power supply sensor 221 may be a current sensor, a voltage sensor, a power meter, or other device capable of being used to monitor power consumption of the interconnect device 100. A current sensor for example may measure flow of electric current (in amperes) from a power supply device 106 to the interconnect device 100. Such a current sensor may be, for example, a Hall-effect current sensor, a current transformer, a shunt resistor, or other type of component capable of being used to determine an amount of current. From the current, the interconnect device 100 may be capable of determining an amount of power consumed at any given time. In some implementations, a current sensor may be used along with a voltage sensor to measure the amount of power consumed. Power data 215 from the power supply sensor 221 may be ready by, for example, processing circuitry 209, and may be stored in memory 212.

FIG. 3 illustrates elements of routing circuitry 206 of an interconnect device 100 in accordance with one or more implementations of the present disclosure. One or more ingress ports 203 may, upon receiving data, transmit the data to one or more ingress processing circuits 303. In some implementations, each ingress port 203 may be associated with a dedicated ingress processing circuit 303, while in other implementations, multiple ingress ports 203 may share an ingress processing circuit 303.

Each ingress processing circuit 303 may include one or more of a forward error correction (FEC) circuit 306, a decryption engine circuit 309, a control plane 312, and/or other circuits and components which may handle ingress packets and non-packetized ingress data. An FEC circuit 306 as described herein may be used to perform error detection and correction for packets received from a port 203 before the packets are directed to an egress port. The FEC circuit 306 may receive ingress data from a port 203 and, after performing FEC, output the received ingress data or a processed version of the ingress data to a decryption engine circuit 309.

A decryption engine circuit 309 as described herein may be used to decrypt all or a portion of received packets to enable the interconnect device 100 to determine a port 203 from which to send each packet. The decryption engine circuit 309 may be capable of ensuring that sensitive data remains protected from unauthorized access during traversal of the data through the interconnect device 100. The decryption engine circuit 309 may output received packets or data associated with received packets to one or more shared buffer circuits 318 via a bandwidth measurement circuit 315 as described below. The decryption engine circuit 309 may also output data associated with received packets to the control plane 312.

A control plane 312 as described herein may be used to manage how received data packets are forwarded and handled within the interconnect device 100. The control plane 312 may receive data associated with a received packet from the decryption engine circuit 309 and, based on the data associated with received packet, write instructions to one or more queueing circuits 321 as described below.

Each of the FEC circuit 306, decryption engine circuit 309, control plane 312, and/or other circuits and components of the ingress processing circuits 303 may include one or more of an ASIC, FPGA, digital signal processor (DSP), network processor, accelerator, hardware secure module, CPU, and/or other components and circuits capable of performing ingress processing. As should be appreciated, each ingress processing circuit 303 of an interconnect device 100 may include one or more additional circuits and components in addition to or instead of the FEC circuit 306, decryption engine circuit 309, and control plane 312 described above.

Each of the ingress processing circuits 303 of the interconnect device 100 may be enabled to write data to a shared-buffer circuit 318 and a queueing circuit 321. Packets to be egressed from the interconnect device 100 may be stored in a shared-buffer circuit 318. Data which may be used by egress processing circuits 327 to route packets to egress ports 203 may be written to the queuing circuits 321. Once the queueing circuit 321 assigns a particular packet to a particular egress port 203, packet data stored in the shared buffer circuit 318 may be read by an egress processing circuit 327 associated with the particular egress port 203.

Data to be sent from the interconnect device 100 may be processed by one or more egress processing circuits 327. In some implementations, each port 203 which is used for egress may be associated with a dedicated egress processing circuit 327. In other implementations, multiple egress ports 203 may share one or more egress processing circuits 327.

An egress processing circuit 327 may include, but should not be considered as limited to, a packet modifier 330 and an encryption engine 333. A packet modifier 330 as described herein may include circuitry such as an ASIC, an FPGA, or other componentry capable of adjusting packets before the packets are transmitted from the interconnect device. Such adjustments may include, for example, the adding or removal of tags, modification of settings and packet header data, and other modifications. An encryption engine 333 as described herein may include circuitry such as an ASIC, an FPGA, or other componentry capable of encrypting packets before the packets are transmitted from the interconnect device. Such encryption may include, for example, use of encryption algorithms such as Advanced Encryption Standard (AES), RSA, or other algorithms.

After being processed by an egress processing circuit 327, a packet may be transmitted from the interconnect device 100 via an egress port 203. The egress port 203 may be directly connected to an ultimate destination of the packet or may be connected to another interconnect device 100 which may forward the packet towards the ultimate destination.

As described above, routing circuitry 206 of an interconnect device 100 may be capable of throttling the traversal of data through the interconnect device 100 by performing throttling mechanisms. The routing circuitry 206 may include one or more throttling circuits 324. While the throttling circuits 324 of the routing circuitry 206 of FIG. 3 are illustrated as between the queueing circuits 321 and the egress processing circuits 327, it should be appreciated that throttling circuits 324 may alternatively or additionally be placed in other locations.

As illustrated in FIG. 3, power supply sensor(s) 221 may sense an amount of power consumed by the routing circuitry 206 from one or more power supply devices 106. A bandwidth measurement circuit 315 may be used to measure an amount of bandwidth traversing the routing circuitry 206. One or more throttling counters 336 may be used to count a number of activations of the throttling circuits 324. Each of the power supply sensors 221, bandwidth measurement circuits 315, and throttling counters 336 may be monitored by processing circuitry 209. The processing circuitry 209 may record the raw data or may process the data and store the data to memory 212 in the form of power data 215, bandwidth data 218, and throttling data 227.

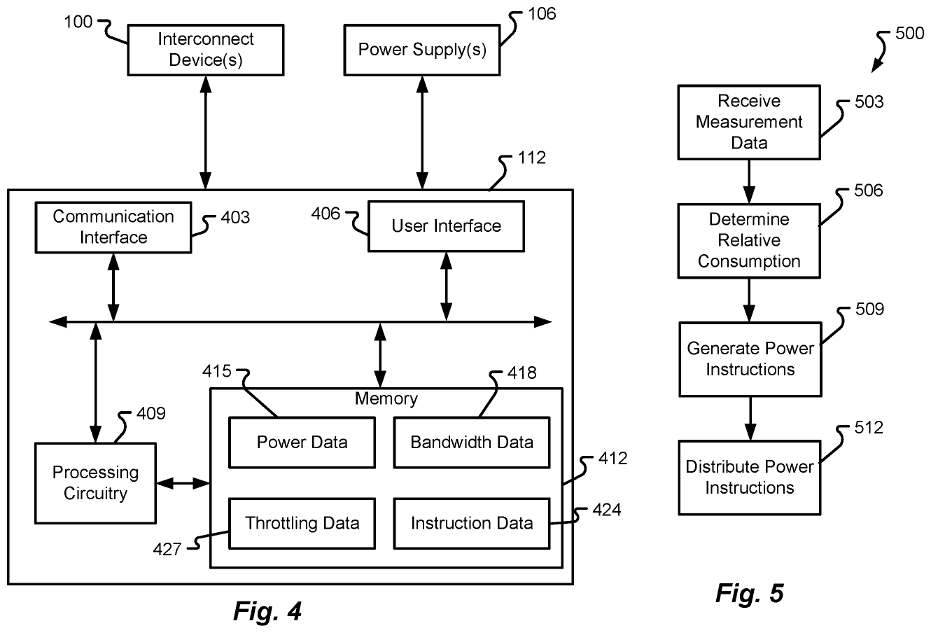

As illustrated in FIG. 4, a controller 112 may be configured to receive measurement data from interconnect devices 100, generate power instructions, and distribute power instructions to the interconnect devices 100. As described above, a controller 112 may not be necessary and the functions associated with the controller 112 may be performed by one or more of the interconnect devices 100.

Similar to the interconnect device 100 described above in relation to FIG. 2, a controller 112 may include processing circuitry 409 and memory 412. A controller may also in some implementations include a communication interface 403 and a user interface 406.

The communication interface 403 of a controller 112 may be configured to receive measurement data and to transmit power instruction data to interconnect devices 100. The communication interface 403 may in some implementations include a network interface controller or other circuitry capable of communicating with interconnect devices 100 and/or other elements. While the systems and methods described herein describe measurement data being captured by each interconnect device 100, in some implementations, measurement data may be measured directly by the controller 112. For example, a controller 112 may be capable of reading power sensors within or external to each interconnect device 100 to determine a power consumption of each interconnect device 100.

A user interface 406 of a controller 112 may enable a user to interact directly with the controller 112. For example, a user interface 406 may include one or more of a user input device, a display, and/or other elements which may enable a user to adjust configuration settings and cause the controller 112 to deploy particular power management systems as described herein.

Processing circuitry 409 of a controller 112 may execute software and/or firmware to configure and manage the controller 112, such as an operating system and management tools. In some implementations, the processing circuitry 409 may be configured to receive power consumption and other data from external devices such as interconnect devices 100. Processing circuitry 409 of a controller 112 may be capable of analyzing data received from interconnect devices 100, determining relative power consumption and/or bandwidth levels, generating power instructions for each of the interconnect devices 100, and transmitting the power instructions to the other interconnect devices 100 as described in greater detail below. However, as described above, in other implementation, an interconnect device 100 may perform the features of a controller 112 as described herein and a dedicated controller 112 may not be necessary.

The processing circuitry 409 may also be capable of storing such power instructions in memory 412 such as in the form of instruction data 424. Memory 412 of a controller 112 as described herein may comprise one or more memory elements capable of storing configuration settings, instruction data 424, application data, operating system data, and other data. Such memory elements may include, for example, RAM, DRAM, flash memory, NVRAM, TCAM, SRAM, and/or memory elements of other formats.

Memory 412 of a controller 112 may also store data such as power data 415, bandwidth data 418, and throttling data 427 as may be received from interconnect devices 100. As each interconnect device 100 operates, the interconnect devices 100 may transmit such data to the controller 112 on a periodic or continuous basis.

Each of the power data 215, bandwidth data 218, and throttling data 227 received by the controller 112 from interconnect devices 100 may be timestamped and stored in memory 412 as power data 415, bandwidth data 418, and throttling data 427. In some implementations, one or more of the power data 415, bandwidth data 418, and throttling data 427 may be used by the controller 112 to compute information such as an average power consumption, average bandwidth, average number of throttling mechanisms performed, and/or other information. In some implementations, one or more of the power data 415, bandwidth data 418, and throttling data 427 may be compared with one or more other of the power data 415, bandwidth data 418, and throttling data 427 to determine variables such as a power per bandwidth utilization over time.

The controller 112 may be configured to receive power data 215, bandwidth data 218, and throttling data 227 from a number of interconnect devices 100 and to generate power instructions based on the power data 215, bandwidth data 218, and throttling data 227 from each device as described below in relation to the method 500 of FIG. 5. Each interconnect device 100 may receive in return a power instruction which may be used to determine a level of power consumption at which the interconnect device 100 should operate.

The controller 112, or in some implementations an interconnect device 100, may be configured to budget a particular amount of power to consume from the power supply device 106. The amount of power may be based on instruction data 224 stored in memory 212. The budgeted amount of power may be a maximum amount of power which the interconnect device 100 may receive from the power supply device 106.

As illustrated in FIG. 5, an example method 500 may be implemented by an interconnect device 100 as described herein to generate and distribute power instructions based on data received from one or more other interconnect devices 100. As described above, an interconnect device 100 may be, for example, a switch or other type of computing system capable of receiving and forwarding data in a network. The interconnect device 100 may be utilized by one or more processing devices 103 and/or client devices 109 to provide interconnect services with one or more other processing devices 103 and/or client devices 109. The interconnect device 100 may receive data from one or more interconnect devices 100. Such data may include, for example, power data 215, bandwidth data 218, and throttling data 227. The interconnect device 100 may process the received data, compare power consumption and/or bandwidth rates of each of the other interconnect devices, generate power instructions based on the relative power consumption and/or bandwidth rates, and distribute the power instructions to the interconnect devices 100. This process is described in greater detail below.

While described as being performed by an interconnect device 100, it should be appreciated the same method 500 may be performed by another computing system such as a central controller. Such a controller may be enabled to perform the steps of receiving measurement data from interconnect devices 100, determining relative power consumption of the interconnect devices 100, generating power instructions, and distributing the power instructions to the interconnect devices 100. While the description provided below and elsewhere describes such steps as being performed by one or the interconnect devices 100 the present disclosure should not be considered as being limited to such an implementation.

At 503, the interconnect device 100 may receive measurement data from a plurality of interconnect devices 100. As described above, each interconnect device 100 may collect power data 215 and/or performance measurement data such as bandwidth data 218, and/or throttling data 227.

In some implementations, an assumption may be made that each interconnect device 100 processes an equivalent amount of data over time. If one interconnect device 100 consumes power in excess to that of other interconnect devices 100, a determination may be made that that interconnect device 100 is less efficient as compared to other interconnect devices 100.

Similarly, if one interconnect device 100 consumes less power than that of other interconnect devices 100, a determination may be made that that interconnect device 100 is more efficient as compared to other interconnect devices 100.

In such implementations, if one interconnect device 100 consumes a greater amount of power on average, more power can be budgeted to that interconnect device 100 and less power may be budgeted to interconnect devices 100 that consume less power.

In some implementations, instead of or in addition to power data 215, the interconnect device 100 may receive performance measurement data such as bandwidth data 218, and/or throttling data 227. For example, the interconnect device 100 may receive throttling data 227 associated with throttling mechanisms performed by one or more other interconnect devices 100. The interconnect device 100 may also or alternatively receive bandwidth data 218 indicating an average level or total amount of bandwidth of data traversing each of the other interconnect devices 100.

At 506, the interconnect device 100 may determine, based on the measurements, a relative power consumption of each of the other interconnect devices 100. As described above, the interconnect device 100 receives measurement data from a number of other interconnect devices 100. The received data may be power consumption data or performance data such as bandwidth data and/or throttling data.

In the case of power consumption data, the interconnect device 100 may determine the relative power consumption of each of the other interconnect devices 100, and in some implementations the interconnect device 100 itself, in a number of ways. For example, the interconnect device 100 may sum a total of all the received power consumption for a particular period of time and divide by each received measurement to determine a percent of the total for each interconnect device 100.

Many factors can affect efficiency, for example, different operating temperatures may cause different switches to have different power consumption levels. For power consumption data received over a long enough period of time, an assumption may be made that the average workloads across the interconnect devices 100 are relatively equal. Therefore, an assumption may be made that interconnect devices 100 which consumed relatively more power are relatively less efficient than the other interconnect devices 100.

In some implementations, the interconnect device 100 may receive performance data such as bandwidth data and/or throttling data in addition to or instead of power consumption data. In the case of bandwidth data, the interconnect device 100 may seek to allocate additional power to interconnect devices 100 with lower levels of bandwidth as compared to interconnect devices 100 with higher levels of bandwidth. In the case of throttling data, the interconnect device 100 may seek to allocate additional power to interconnect devices 100 with higher instances of throttling mechanisms being activated.

In implementations in which the interconnect device 100 receives performance data such as bandwidth data and/or throttling data in addition to power consumption data, the interconnect device 100 may be configured to balance the relative power consumption of each device with the performance data to determine an amount of power to allocate to each device. As described above, the interconnect device 100 may seek to allocate additional power to interconnect devices 100 with relatively lower levels of bandwidth as well as to interconnect devices 100 with relatively higher instances of throttling mechanisms being activated. The interconnect device 100 may balance these factors with the relative power consumption of each device.

In implementations in which the interconnect device 100 receives performance data such as bandwidth data and/or throttling data instead of power consumption data, the interconnect device 100 may be configured to determine an amount of power to allocate to each device based only on the performance data. As described above, the interconnect device 100 may seek to allocate additional power to interconnect devices 100 with relatively lower levels of bandwidth as well as to interconnect devices 100 with relatively higher instances of throttling mechanisms being activated.

At 509, the interconnect device 100 may generate power instructions for each of the other interconnect devices based on the relative power consumption and/or performance data of each interconnect device.

Power instructions may include a maximum amount of power for the respective interconnect device 100 to consume. A power instruction may be received by an interconnect device 100 and may cause the interconnect device 100 to consume a particular amount of power.

In some implementations, power instructions may not be received by each interconnect device 100 and may instead be configured to control a power supply device 106 to allocate or budget a particular amount of power to specific interconnect devices 100. In some embodiments, a combination may be implemented, in which a power supply device 106 and interconnect devices 100 are each instructed regarding budgeted power levels.

Power instructions may be transmitted to other interconnect devices 100, and/or power supply devices 106, in the form of instructions which may instruct software or firmware of each interconnect device 100 to operate the interconnect device 100 at a particular power level. Upon receiving power instructions, an interconnect device 100 may begin operating at the instructed power level.

Power instructions may be generated based on the relative power consumption of each device. As an example, an interconnect device 100 which provided power data indicating the interconnect device 100 was operating at a higher power level as compared to other interconnect devices 100 may be allocated a higher level of power as compared to an interconnect device 100 which provided power data indicating the interconnect device 100 was operating at a lower power level.

As described above, bandwidth data may also play a role in generating power instructions. As an example, an interconnect device 100 which provided bandwidth data indicating the interconnect device 100 was operating at a lower bandwidth level as compared to other interconnect devices 100 may be allocated a higher level of power as compared to an interconnect device 100 which provided power data indicating the interconnect device 100 was operating at a higher bandwidth level, as devices with less bandwidth may be assumed to be less efficient than devices with higher bandwidth.

In addition to the power data and bandwidth data, throttling data may also play a role in generating power instruction, with a goal of reducing the total number of throttling occurrences. The interconnect device 100 may factor in throttling data in a number of ways. For example, the interconnect device 100 may allocate additional power to interconnect devices 100 showing relatively high numbers of throttling mechanism activations. When an interconnect device 100 experiences relatively high numbers of throttling mechanism activations, it may be a sign that the interconnect device does not have sufficient power to meet the bandwidth requirements. By budgeting additional power for interconnect devices 100 showing relatively high numbers of throttling mechanism activations, the interconnect devices 100 may be enabled to lessen the number of throttling mechanism activations.

While the systems and methods described herein describe distributing power consumption budgets to achieve equal performance across a group of interconnect devices, it should be appreciated that in some implementations other configurations may be possible. As an example, an interconnect device 100 may be configured to allocate additional power to specific devices such as to support better quality of service (QOS) or to achieve better performance for specific devices.

As should also be appreciated, the interconnect device 100 performing the method 500 may also determine its own power consumption relative to the power consumption and/or bandwidth of other interconnect devices and generate power instructions for itself. In such an implementation the interconnect device 100 may generate power instructions for itself and for interconnect devices 100 having sent measurement data to the interconnect device 100. The interconnect device 100 may then save its own power instructions in memory and transmit power instructions to the other interconnect devices 100 as described below.

At 512, the interconnect device 100 may distribute the generated power instructions to a respective interconnect device 100. For example, the interconnect device 100 may generate a specific power instruction for each interconnect device 100 of a group of interconnect devices 100. The interconnect device 100 may transmit the specific power instruction to the interconnect device 100 for which the specific power instruction was generated.

Upon receiving power instructions, an interconnect device 100 may store the power instructions in memory and may begin consuming power at a power level indicated in the power instructions. The interconnect device 100 may be one of a group of interconnect devices 100 performing a workload for a computing device such as a processing device 103 and/or a client device 109.

In response to distributing the respective power instructions to each interconnect device 100, a variety of configurable outcomes may be achieved. For example, bandwidth of traffic, packet rates, and compute operations across the two or more switching devices may be substantially equalized. That is, the power instructions may be configured to cause the interconnect devices 100 to operate at a similar bandwidth, a similar packet rate, a similar level of compute operations, or other factors.

In some implementations, throttling mechanism activations across the group of interconnect devices may be reduced. For example, by budgeting additional power to interconnect devices experiencing increased numbers of throttling mechanism activations, the interconnect devices experiencing increased numbers of throttling mechanism activations may be enabled to process data more quickly and the rate of throttling mechanism activations may decrease.

In some implementations, in response to distributing the respective power instructions to each device from the two or more devices, additional power may be allocated to one or more interconnect devices 100 and less power may be allocated to one or more other interconnect devices 100. The different amounts of power may result in the interconnect devices 100 providing substantially the same or different levels of bandwidth depending on the particular configuration. In some instances, the instructions may be configured such that one or more of bandwidth of traffic, packet rates, and compute operations across certain interconnect devices 100 increase relative to other interconnect devices 100. Such an instance may be beneficial in certain scenarios such as in cases where certain interconnect devices 100 provide higher priority traffic as compared to other interconnect devices 100.

In some implementations, measurement data and power instructions generated based on the measurement data may be used for machine learning training purposes. Additional data may also be used as training data. For example, in some implementations measurement data may include context information such as an indication of one or more applications executing on a processing device 103, a client device 109, and/or an interconnect device 100.

A machine learning model may be created which learns to predict power instructions based on an application or combination of applications executing on one or more devices. The machine learning model may be configured to receive application data and to output power instructions for one or more interconnect devices 100 based on the application data.

Such an implementation may be useful as certain applications may cause interconnect devices 100 to consume greater or lesser amount of power and/or to be more or less efficient. An interconnect device 100 or other device executing a machine learning model may be enabled to receive power instructions for a group of interconnect devices 100, store the respective power instructions in memory, associate the power instructions with one or more applications executed by a computing device, and train the machine learning model based on the associations. In this way, a model may be configured to learn about what application is running and allocate power budget ahead of time.

The present disclosure encompasses methods with fewer than all of the steps identified in FIG. 5 (and the corresponding description of the method 500), as well as methods that include additional steps beyond those identified in FIG. 5 (and the corresponding description of the method 500). The present disclosure also encompasses methods that comprise one or more steps from the methods described herein, and one or more steps from any other method described herein.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. A device comprising one or more circuits to:
receive measurements from two or more switching devices;
determine, based on the measurements, a relative power consumption of each switching device from the two or more switching devices;
generate, based on the relative power consumption of each switching device from the two or more switching devices, respective power instructions for each switching device from the two or more switching devices; and
distribute the respective power instructions to each switching device from the two or more switching devices.

2. The device of claim 1, wherein each switching device from the two or more switching devices performs a workload for a computing device, wherein in response to distributing the respective power instructions to each switching device from the two or more switching devices, one or more of bandwidth of traffic, packet rates, and compute operations across the two or more switching devices are substantially equalized.

3. The device of claim 2, wherein the one or more circuits are further to store the respective power instructions for each switching device from the two or more switching devices in memory and associate the respective power instructions with one or more applications executed by the computing device.

4. The device of claim 1, wherein the one or more circuits are further to receive data associated with one or more throttling mechanisms performed by at least one of the two or more switching devices, wherein the respective power instructions are generated further based on the data associated with one or more throttling mechanisms.

5. The device of claim 4, wherein, in response to distributing the respective power instructions, a rate of throttling occurrences across the two or more switching devices is reduced.

6. The device of claim 1, wherein the one or more circuits are further to determine an average power consumption over a period of time for each switching device from the two or more switching devices.

7. The device of claim 6, wherein the relative power consumption comprises an average relative power consumption of each switching device from the two or more switching devices over time.

8. The device of claim 1, wherein in response to distributing the respective power instructions to each device from the two or more devices, more power is allocated to one or more devices of the two or more devices than other devices of the two or more devices.

9. The device of claim 8, wherein one or more of bandwidth of traffic, packet rates, and compute operations across the one or more devices increase relative to the other devices.

10. The device of claim 1, wherein the measurements comprise one or more of power measurements and performance measurements.

11. A method comprising:
receiving measurements from two or more switching devices;
determining, based on the measurements, a relative power consumption of each switching device from the two or more switching devices;
generating, based on the relative power consumption of each switching device from the two or more switching devices, respective power instructions for each switching device from the two or more switching devices; and
distributing the respective power instructions to each switching device from the two or more switching devices.

12. The method of claim 11, wherein each switching device from the two or more switching devices performs a workload for a computing device, wherein in response to distributing the respective power instructions to each switching device from the two or more switching devices, one or more of bandwidth of traffic, packet rates, and compute operations across the two or more switching devices are substantially equalized.

13. The method of claim 12, further comprising storing the respective power instructions for each switching device from the two or more switching devices in memory and associating the respective power instructions with one or more applications executed by the computing device.

14. The method of claim 11, further comprising receiving data associated with one or more throttling mechanisms performed by at least one of the two or more switching devices, wherein the respective power instructions are generated further based on the data associated with one or more throttling mechanisms.

15. The method of claim 14, wherein in response to distributing the respective power instructions, a rate of throttling occurrences across the two or more switching devices is reduced.

16. The method of claim 11, further comprising determining an average power consumption over a period of time for each switching device from the two or more switching devices.

17. The method of claim 16, wherein the relative power consumption comprises an average relative power consumption of each switching device from the two or more switching devices over time.

18. A computing system comprising:
a plurality of switching circuits; and
a controller circuit to:
receive measurements from the plurality of switching circuits;
determine, based on the measurements, a relative power consumption of each switching circuit from the plurality of switching circuits;
generate, based on the relative power consumption of each switching device, respective power instructions for each switching circuit from the plurality of switching circuits; and
distribute the respective power instructions to each switching circuit from the plurality of switching circuits.

19. The computing system of claim 18, wherein the plurality of switching circuits performs a workload for a computing device, wherein in response to distributing the respective power instructions to each switching circuit from the plurality of switching circuits, one or more of bandwidth of traffic, packet rates, and compute operations, across the plurality of switching circuits is substantially equalized.

20. The computing system of claim 19, wherein the controller circuit is further to store the respective power instructions for each switching circuit from the plurality of switching circuits in memory and associate the respective power instructions for each switching circuit from the plurality of switching circuits with one or more applications executed by the computing device.
